(19) United States
(12) Patent Application Publication
(10) Pub. No.: US 2024/0059887 A1
(43) Pub. Date: Feb. 22, 2024

(54) POLYMER BLENDS OF THERMOPLASTIC ELASTOMER AND CROSS-LINKED SILANE GRAFTED POLYOLEFIN

(71) Applicant: Avient Corporation, Avon Lake, OH (US)

(72) Inventor: William PEPE, Ringwood, IL (US)

(73) Assignee: Avient Corporation, Avon Lake, OH (US)

(21) Appl. No.: 18/259,569

(22) PCT Filed: Dec. 22, 2021
(86) PCT No.: PCT/US2021/064796

§ 371 Date: Jun. 27, 2023

Related U.S. Application Data
(60) Provisional application No. 63/132,145, filed on Dec. 30, 2020.

(51) Int. Cl. C08L 53/02; C08L 51/08

(52) U.S. Cl. CPC C08L 53/025; C08L 51/085; C08L 2205/02

(57) ABSTRACT

Embodiments of the present disclosure are directed to polymer blends comprising thermoplastic elastomer and 4 wt % to 50 wt % of cross-linked silane grafted polyolefin. The thermoplastic elastomer comprises a Shore A hardness from 0 to 80 as measured in accordance with ASTM D2240 and a compression set greater than or equal to 80% as measured in accordance with ASTM D395 at 125 C. The cross-linked silane grafted polyolefin comprises a compression set less than or equal to 70% as measured in accordance with ASTM D395 at 125 C.

### CLAIM OF PRIORITY

This application claims the benefit of U.S. Provisional Patent Application Ser. No. 63/132,145 bearing Attorney Docket Number 12020013 and filed on Dec. 30, 2020, which is hereby incorporated by reference in its entirety.

### TECHNICAL FIELD

Embodiments of the present disclosure are generally related to polymer blends, and are specifically related to polymer blends of thermoplastic elastomer and cross-linked silane grafted polyolefin having improved compression set at higher temperatures.

### BACKGROUND

Polymer blends including thermoplastic elastomer are widely used, such as in consumer, healthcare, and automotive applications, due to their customizability, which results from their relatively low hardness (i.e., relatively high softness) and relatively high tensile elongation and strength at break. However, the properties of the thermoplastic elastomer start to degrade at higher temperatures (e.g., greater than or equal to 70° C.) and may not be suitable for certain high temperature applications.

Accordingly, a need exists for polymer blends that have improved performance at higher temperatures while providing the softness and tensile elongation and strength at break desired when using thermoplastic elastomer polymer blends.

### SUMMARY

Embodiments of the present disclosure are directed to polymer blends of thermoplastic elastomer and cross-linked silane grafted polyolefin, which provide improved high temperature performance, as evidenced by improved compression set at higher temperatures, and exhibit sufficient hardness and tensile elongation and strength at break.

According to one embodiment, a polymer blend is provided. The polymer blend comprises thermoplastic elastomer and 4 wt % to 50 wt % of cross-linked silane grafted polyolefin. The thermoplastic elastomer comprises a Shore A hardness from 0 to 80 as measured in accordance with ASTM D2240 and a compression set greater than or equal to 80% as measured in accordance with ASTM D395 at 125° C. The cross-linked silane grafted polyolefin comprises a compression set less than or equal to 70% as measured in accordance with ASTM D395 at 125° C.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DETAILED DESCRIPTION

Reference will now be made in detail to various embodiments of polymer blends, specifically polymer blends comprising thermoplastic elastomer and 4 wt % to 50 wt % of cross-linked silane grafted polyolefin. The thermoplastic elastomer comprises a Shore A hardness from 0 to 80 as measured in accordance with ASTM D2240 and a compression set greater than or equal to 80% as measured in accordance with ASTM D395 at 125° C. The cross-linked silane grafted polyolefin comprises a compression set less than or equal to 70% as measured in accordance with ASTM D395 at 125° C.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The terms “0 wt %,” “free,” and “substantially free,” when used to describe the weight and/or absence of a particular component in a polymer blend means that the component is not intentionally added to the polymer blend. However, the polymer blend may contain traces of the component as a contaminant or tramp in amounts less than 0.05 wt %.

The term “wt %,” as described herein, refers to wt % based on the weight of the polymer blend, unless otherwise noted.

The term “Shore A hardness,” as described herein, refers to the hardness of a material as measured according to ASTM D2240.

The term “compression set,” as described herein, refers to the ability of a material to return to its original thickness after prolonged compressive stress as measured according to ASTM D395 at the temperature indicated.

The term “tensile strength at break,” as described herein, refers to the maximum stress that a material can withstand while stretching before breaking as measured according to ASTM D638 at 23° C. and a rate of strain of 0.85 mm/s.

The term “tensile elongation at break,” as described herein, refers to the ratio between increased length and initial length after breakage as measured according to ASTM D638 at 23° C. and a rate of strain of 0.85 mm/s.

The term “viscosity,” as described herein, refers to the resistance of a material to deformation as measured according to ASTM D3835 at a rate of 67.023/sec.

The term “specific gravity,” as described herein, refers to the ratio of the density of a material to the density of water as measured according to ASTM D792.

As discussed hereinabove, the thermoplastic elastomer blends have a relatively low hardness and relatively high tensile elongation and strength at break, which allows for the customized use of these blends in a wide range of applications, such as consumer, healthcare, and automotive. However, thermoplastic elastomer may start to degrade at higher temperatures (e.g., greater than or equal to 70° C.). Accordingly, thermoplastic elastomer blends may not be suitable for certain higher temperature applications.

Disclosed herein are polymer blends which mitigate the aforementioned problems. Specifically, the polymer blends disclosed herein comprise a blend of thermoplastic elastomer and cross-linked silane grafted polyolefin, which results in a polymer blend having improved compression set at higher temperatures (e.g., greater than or equal to 70° C.) as compared to a conventional thermoplastic elastomer blend, and sufficient Shore A hardness (e.g., less than or equal to 80), tensile elongation at break (e.g., greater than or equal to 150%), and tensile strength at break (e.g., greater than or equal to 500 kPa). The cross-linked silane grafted polyolefin described herein has a compression set of less than 70% at 125° C. The cross-linked silane grafted polyolefin may be dispersed within the thermoplastic elastomer to improve the compression set of the resulting polymer blend. Though, due to its cross-linked nature, adding cross-linked silane grafted polyolefin may increase the Shore A hardness and decrease the tensile elongation and strength at break of the polymer blend, which may be undesirable, particularly in conventional thermoplastic elastomer blend applications. Accordingly, the cross-linked silane grafted polyolefin described herein is added in amounts such that the compression set of the polymer blend is improved, as compared to a conventional thermoplastic elastomer blend, while the Shore A hardness and the tensile elongation and strength at break of the polymer blend remain within the desired ranges.

The polymer blends disclosed herein may generally be described as comprising thermoplastic elastomer and cross-linked silane grafted polyolefin.

Thermoplastic Elastomer

As described hereinabove, thermoplastic elastomer imparts a desired softness (e.g., Shore A hardness less than or equal to 80), tensile elongation at break (e.g., greater than or equal to 150%), and tensile strength at break (e.g., greater than or equal to 500 kPa) to the polymer blend required for customizable consumer, healthcare, and automotive applications.

Various thermoplastic elastomers are considered suitable for the present polymer blends. In embodiments, the thermoplastic elastomer may comprise a styrene copolymer. In embodiments, the styrene copolymer may comprise a styrene-butadiene block copolymer (SBC). In embodiments, the SBC may comprise a styrene-ethylene/butylene-styrene block copolymer (SEBS), a styrene-(ethylene/propylene)-styrene block copolymer (SEEPS), a styrene isoprene block copolymer (SIS), a styrene-isobutylene-styrene block copolymer (SIBS), or combinations thereof. For example, in embodiments, the styrene copolymer may comprise a SEBS and a SEEPS, a SEBS and a SIS, a SEBS and a SIBS, a SEEPS and a SIS, a SEEPS and a SIBS, or even a SIS or a SIBS.

In embodiments, the thermoplastic elastomer may further comprise vibration damping thermoplastic elastomer (VDT), thermoplastic polyurethane (TPU), thermoplastic vulcanizate (TPV), thermoplastic polyolefins (TPO), thermoplastic copolyester elastomer (TPC), polyamide thermoplastic elastomer (TPA), thermoplastic styrenic elastomer (TPS), or combinations thereof.

In embodiments, the thermoplastic elastomer may be relatively soft (e.g., Shore A hardness less than or equal to 80) to balance out the relatively harder cross-linked silane grafted polyolefin such that the desired Shore A hardness of the polymer blend (e.g., less than or equal to 80) is achieved. In embodiments, the thermoplastic elastomer may comprise a Shore A hardness greater than or equal to 0, greater than or equal to 10, greater than or equal to 20, or even greater than or equal to 30. In embodiments, the thermoplastic elastomer may comprise a Shore A hardness less than or equal to 80, less than or equal to 70, less than or equal to 60, or even less than or equal to 50. In embodiments, the thermoplastic elastomer may comprise a Shore A hardness from 0 to 80, from 0 to 70, from 0 to 60, from 0 to 50, from 10 to 80, from 10 to 70, from 10 to 60, from 10 to 50, from 20 to 80, from 20 to 70, from 20 to 60, from 20 to 50, from 30 to 80, from 30 to 70, from 30 to 60, or even from 30 to 50, or any and all sub-ranges formed from these endpoints.

In embodiments, the thermoplastic elastomer may have a relatively poor compression set at higher temperatures, which is improved by the addition of the cross-linked silane grafted polyolefin. In embodiments, the thermoplastic elastomer may comprise a compression set at 125° C. greater than or equal to 80%, greater than or equal to 85%, or even greater than or equal to 90%. In embodiments, the thermoplastic elastomer may comprise compression set at 125° C. less than or equal to 100%, less than or equal to 97%, less than or equal to 95%, or even less than or equal to 93%. In embodiments, the thermoplastic elastomer may comprise a compression set at 125° C. from 80% to 100%, from 80% to 97%, from 80% to 95%, from 80% to 93%, from 85% to 100%, from 85% to 97%, from 85% to 95%, from 85% to 93%, from 90% to 100%, from 90% to 97%, from 90% to 95%, or even from 90% to 93%, or any and all sub-ranges formed from any of these endpoints.

In embodiments, the thermoplastic elastomer may comprise a compression set at 70° C. greater than or equal to 40%, greater than or equal to 50%, greater than or equal to 60%, or even greater than or equal to 70%. In embodiments, the thermoplastic elastomer may comprise compression set at 70° C. less than or equal to 100%, less than or equal to 90%, or even less than or equal 80%. In embodiments, the thermoplastic elastomer may comprise compression set at 70° C. from 40% to 100%, from 40% to 90%, from 40% to 80%, from 50% to 100%, from 50% to 90%, from 50% to 80%, from 60% to 100%, from 60% to 90%, from 60% to 80%, from 70% to 100%, from 70% to 90%, or even from 70% to 80%, or any and all sub-ranges formed from any of these endpoints.

In embodiments, thermoplastic elastomer is included in amounts greater than or equal to 50 wt % such that the thermoplastic elastomer may impart the desired Shore A hardness and tensile elongation and strength at break to the polymer blend. In embodiments, the amount of thermoplastic elastomer may be limited (e.g., less than or equal to 96 wt %) and balanced with cross-linked silane grafted polyolefin such that the compression set is improved. In embodiments, the amount of thermoplastic elastomer in the polymer blend may be greater than or equal to 50 wt %, greater than or equal to 60 wt %, greater than or equal to 70 wt %, or even greater than or equal to 80 wt %. In embodiments, the amount of thermoplastic elastomer in the polymer blend may be less than or equal to 96 wt %, less than or equal to 94 wt %, less than or equal to 92 wt %, less than or equal to 90 wt %, or even less than or equal to 88 wt %. In embodiments, the amount of thermoplastic elastomer in the polymer blend may be from 50 wt % to 96 wt %, from 50 wt % to 94 wt %, from 50 wt % to 92 wt %, from 50 wt % to 90 wt %, from 50 wt % to 88 wt %, from 60 wt % to 96 wt %, from 60 wt % to 94 wt %, from 60 wt % to 92 wt %, from 60 wt % to 90 wt %, from 60 wt % to 88 wt %, from 70 wt % to 96 wt %, from 70 wt % to 94 wt %, from 70 wt % to 92 wt %, from 70 wt % to 90 wt %, from 70 wt % to 88 wt %, from 80 wt % to 96 wt %, from 80 wt % to 94 wt %, from 80 wt % to 92 wt %, from 80 wt % to 90 wt %, or even from 80 wt % to 88 wt %, or any and all sub-ranges formed from any of these endpoints.

In embodiments, the thermoplastic elastomer may have a relatively high tensile elongation at break (e.g., greater than or equal to 500%) that may be imparted to the polymer blend. In embodiments, the thermoplastic elastomer may comprise a tensile elongation at break greater than or equal to 500% or even greater than or equal to 750%. In embodiments, the thermoplastic elastomer may comprise a tensile elongation at break less than or equal to 1300%, less than or equal to 1100%, or even less than or equal to 1000%. In embodiments, the thermoplastic elastomer may comprise a tensile elongation at break from 500% to 1300%, from 500% to 1100%, from 500% to 1000%, from 750% to 1300%, from 750% to 1100%, or even from 750% to 1000%, or any and all sub-ranges formed from any of these endpoints.

In embodiments, the thermoplastic elastomer may have a relatively high tensile strength at break (e.g., greater than or equal to 800 kPa) that may be imparted to the polymer blend. In embodiments, the thermoplastic elastomer may comprise tensile strength at break greater than or equal to 800 kPa, greater than or equal to 1000 kPa, or even greater than or equal to 2000 kPa. In embodiments, the thermoplastic elastomer may comprise a tensile strength at break less than or equal to 12000 kPa, less than or equal to 8000 kPa, or even less than or equal to 4000 kPa. In embodiments, the thermoplastic elastomer may comprise a tensile strength at break from 800 kPa to 12000 kPa, from 800 kPa to 8000 kPa, from 800 kPa to 4000 kPa, from 1000 kPa to 12000 kPa, from 1000 kPa to 8000 kPa, from 1000 kPa to 4000 kPa, from 2000 kPa to 12000 kPa, from 2000 kPa to 8000 kPa, or even from 2000 kPa to 4000 kPa, or any and all sub-ranges formed from any of these endpoints.

In embodiments, the thermoplastic elastomer may comprise a specific gravity greater than or equal to 0.80, greater than or equal to 0.90, or even greater than or equal to 1.00. In embodiments, the thermoplastic elastomer may comprise a specific gravity less than or equal to 1.30, less than or equal to 1.20, or even less than or equal to 1.10. In embodiments, the thermoplastic elastomer may comprise a specific gravity from 0.80 to 1.30, from 0.80 to 1.20, from 0.80 to 1.10, from 0.90 to 1.30, from 0.90 to 1.20, from 0.90 to 1.10, from 1.00 to 1.30, from 1.00 to 1.20, or even from 1.00 to 1.10, or any and all sub-ranges formed from any of these endpoints.

Suitable commercial embodiments of the thermoplastic elastomer are available under the VERSAFLEX brand from Avient, such as grades 2800-17 CL 2003X CL 2000X, CL 30, OM 1040X-1, VDT 4132, VDT 4204-40B, and CE 3120-65. Table 1 shows certain properties of VERSAFLEX 2800-17, VERSAFLEX CL 2003X VERSAFLEX CL 2000X VERSAFLEX CL 30, VERSAFLEX OM 1040 X-1, VERSAFLEX VDT 4132, VERSAFLEX VDT 4202-40B, and VERSAFLEX CE 3120-65.

TABLE 1

| | VERSAFLEX | VERSAFLEX | VERSAFLEX | VERSAFLEX |
|---|---|---|---|---|
| | 2800-17 | CL 2003X | CL 2000X | CL 30 |
| Shore A hardness | 0 | 0 | 3 | 30 |
| Compressionset | 15 | 23 | 23 | 11 |
| (%) (23° C.) | | | | |
| Tensile elongation | 1259 | 1100 | 850 | 870 |
| at break (%) | | | | |
| Tensile strength | 1151 | 2070 | 890 | 5180 |
| at break (kPa) | | | | |
| Specific gravity | 0.85 | 0.87 | 0.97 | 0.89 |

TABLE 1
cont.

| | VERSAFLEX | VERSAFLEX | VERSAFLEX | VERSAFLEX |
|---|---|---|---|---|
| | OM 1040 X-1 | VDT 4132 | VDT 4202-40B | CE 3120-65 |
| Shore A hardness | 42 | 32 | 40 | 67 |
| Compression set | 22.0 | — | 11.0 | — |
| (%) (23° C.) | | | | |
| Tensile elongation | 580 | 900 | 560 | 700 |
| at break (%) | | | | |
| Tensile strength | 3470 | — | 4833 | 11400 |
| at break (kPa) | | | | |
| Specific gravity | 0.85 | 0.90 | 1.00 | 1.16 |

Cross-linked Silane Grafted Polyolefin

As stated hereinabove, cross-linked silane grafted polyolefin increases the compression set, and the combination of thermoplastic elastomer and cross-linked silane grafted polyole fin results in a polymer blend with better high temperature performance as compared to a conventional thermoplastic elastomer blend.

Accordingly, in embodiments, cross-linked silane grafted polyolefin is included in amounts greater than or equal to 4 wt % such that the cross-linked silane grafted polyolefin may increase the compression set of the polymer blend as compared to a conventional thermoplastic elastomer blend. In embodiments, the amount of cross-linked silane grafted polyolefin may be limited (e.g., less than or equal to 50 wt %) such that the Shore A hardness is not increased above a desired value (e.g., less than or equal to 80) and tensile elongation and strength at break of the polymer blend are not reduced below a desired value (e.g., greater than or equal to 150% and greater than or equal to 500 kPa, respectively). In embodiments, the amount of cross-linked silane grafted polyolefin in the polymer blend may be greater than 4 wt %, greater than or equal to 6 wt %, greater than or equal to 8 wt %, greater than or equal to 10 wt %, or even greater than or equal to 12 wt %. In embodiments, the amount of cross-linked silane grafted polyolefin in the polymer blend may be less than or equal to 50 wt %, less than or equal to 40 wt %, less than or equal to 30 wt %, or even less than or equal to 20 wt %. In embodiments, the amount of cross-linked silane grafted polyolefin in the polymer blend may be from 4 wt % to 50 wt %, from 4 wt % to 40 wt %, from 4 wt % to 30 wt %, from 4 wt % to 20 wt %, from 6 wt % to 50 wt %, from 6 wt % to 40 wt %, from 6 wt % to 30 wt %, from 6 wt % to 20 wt %, from 8 wt % to 50 wt %, from 8 wt % to 40 wt %, from 8 wt % to 30 wt %, from 8 wt % to 20 wt %, from 10 wt % to 50 wt %, from 10 wt % to 40 wt %, from 10 wt % to 30 wt %, from 10 wt % to 20 wt %, from 12 wt % to 50 wt %, from 12 wt % to 40 wt %, from 12 wt % to 30 wt %, or even from 12 wt % to 20 wt %, or any and all sub-ranges formed from any of these endpoints.

In embodiments, the cross-linked silane grafted polyolefin may have a relatively good compression set (e.g., less than or equal to 70% at 125° C.) such that the combination of thermoplastic elastomer and cross-linked silane grafted polyolefin results in a polymer blend having an improved compression set at higher temperatures as compared to a conventional thermoplastic elastomer blend. In embodiments, the cross-linked silane grafted polyolefin may comprise a compression set at 125° C. less than or equal to 70%, less than or equal to 55%, less than or equal to 40%, less than or equal to 25%, or even less than or equal to 20%. In embodiments, the cross-linked silane grafted polyolefin may comprise a compression set at 125° C. greater than or equal to 10%, greater than or equal to 12%, greater than or equal to 14%, or even greater than or equal to 16%. In embodiments, the cross-linked silane grafted polyolefin may comprise a compression set at 125° C. from 10% to 70%, from 10% to 55%, from 10% to 40%, from 10% to 25%, from 10% to 20%, from 12% to 70%, from 12% to 55%, from 12% to 40%, from 12% to 25%, from 12% to 20%, from 14% to 70%, from 14% to 55%, from 14% to 40%, from 14% to 25%, from 14% to 20%, from 16% to 70%, from 16% to 55%, from 16% to 40%, from 16% to 25%, or even from 16% to 20%, or any and all sub-ranges formed from any of these endpoints.

In embodiments, the cross-linked silane grafted polyolefin may comprise polyethylene, polypropylene, or combinations thereof. In embodiments, the polypropylene may comprise a polypropylene homopolymer (i.e., composed of propylene monomers) or a polypropylene copolymer having greater than 50 wt % propylene monomer and an additional comonomer such as C₃-C₁₂ alpha olefins.

In embodiments, the polyethylene may comprise linear low-density polyethylene (LLDPE), low-density polyethylene (LDPE), medium-density polyethylene (HDPE), high-density polyethylene (HDPE), or combinations thereof. In embodiments, the polyethylene may comprise a polyethylene homopolymer (i.e., composed of ethylene monomers) or a polyethylene copolymer having greater than 30 wt % ethylene monomer and an additional comonomer, such as C₃-C₁₂ alpha olefins, ethylene-vinyl acetate (EVA), ethylene butyl acrylate (EBA), or ethyl methacrylate (EMA). In embodiments, the EVA may have a high proportion of vinyl acetate (e.g., greater than or equal to 60 wt %).

In embodiments, the cross-linked silane grafted polyolefin may be dispersed within the thermoplastic elastomer. In embodiments, the silane grafted to the polyolefin may comprise the general formula:

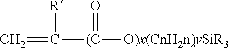

in which R′ is a hydrogen atom or methyl group; x and y are 0 or 1 with the proviso that when x is 1, y is 1; n is an integer from 1 to 12, and each R independently is a hydrolysable organic group such as an alkoxy group having from 1 to 12 carbon atoms (e.g., methoxy, ethoxy, butoxy), aryloxy group (e.g., formyloxy, acetyloxy, propanoyloxy), amino or substituted amino groups (alkylamine, arylamino), or a lower alkyl group having 1 to 6 carbon atoms, with the proviso that not more than two of the three R groups is an alkyl (e.g., vinyl dimethyl methoxy silane).

In embodiments, the silane may be grafted to the polyolefin by any conventional method, such as in the presence of a free radical initiator (e.g., peroxides and azo compounds) or by ionizing radiation. In embodiments, the peroxide initiator may include dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy)hexane, lauryl perodice, and tert-butyl peracetate. In embodiments, the azo compound initiator may be azobisisobutyl nitrite.

In embodiments, the cross-linked silane grafted polyolefin may comprise a Shore A hardness greater than or equal to 55, greater than or equal to 60, greater than or equal to 65, or even greater than or equal to 70. In embodiments, the cross-linked silane grafted polyolefin may comprise a Shore A hardness less than or equal to 95, less than or equal to 90, less than or equal to 85, or even less than or equal to 80. In embodiments, the cross-linked silane grafted polyolefin may comprise a Shore A hardness from 55 to 95, from 55 to 90, from 55 to 85, from 55 to 80, from 60 to 95, from 60 to 90, from 60 to 85, from 60 to 80, from 65 to 95, from 65 to 90, from 65 to 85, from 65 to 80, from 70 to 95, from 70 to 90, from 70 to 85, or even from 70 to 80, or any and all sub-ranges formed from any of these endpoints.

In embodiments, the cross-linked silane grafted polyolefin may comprise a tensile elongation at break greater than or equal to 70%, greater than or equal to 90%, or even greater than or equal to 110%. In embodiments, the cross-linked silane grafted polyolefin may comprise a tensile elongation at break less than or equal to 225%, less than or equal to 175%, less than or equal to 150%, or even less than or equal to 125%. In embodiments, the cross-linked silane grafted polyolefin may comprise a tensile elongation at break from 70% to 225%, from 70% to 175%, from 70% to 150%, from 70% to 125%, from 90% to 225%, from 90% to 175%, from 90% to 150%, from 90% to 125%, from 110% to 225%, from 110% to 175%, from 110% to 150%, or even from 110% to 125%, or any and all sub-ranges formed from any of these endpoints.

In embodiments, the cross-linked silane grafted polyolefin may comprise a tensile strength at break greater than or equal to 3500 kPa, greater than or equal to 4500 kPa, or even greater than or equal to 5500 kPa. In embodiments, the cross-linked silane grafted polyolefin may comprise a tensile strength at break less than or equal to 13000 kPa, less than or equal to 10000 kPa, or even less than or equal to 7000 kPa. In embodiments, the cross-linked silane grafted polyolefin may comprise a tensile strength at break from 3500 kPa to 13000 kPa, from 3500 kPa to 10000 kPa, from 3500 kPa to 7000 kPa, from 4500 kPa to 13000 kPa, from 4500 kPa to 10000 kPa, from 4500 kPa to 7000 kPa, from 5500 kPa to 13000 kPa, from 5500 kPa to 10000 kPa, or even from 5500 kPa to 7000 kPa, or any and all sub-ranges formed from any of these endpoints.

In embodiments, the cross-linked silane grafted polyolefin may comprise a specific gravity greater than or equal to 0.60, greater than or equal to 1.00, greater than or equal to 1.40, greater than or equal to 1.80, greater than or equal to 2.20, greater than or equal to 2.60, or even greater than or equal to 3.00. In embodiments, the cross-linked silane grafted polyolefin may comprise a specific gravity less than or equal to 8.00, less than or equal to 7.50, less than or equal to 7.00, less than or equal to 6.50, less than or equal to 6.00, less than or equal to 5.50, or even less than or equal to 5.00. In embodiments, the cross-linked silane grafted polyolefin may comprise a specific gravity from 0.60 to 8.00, from 0.60 to 7.50, from 0.60 to 7.00, from 0.60 to 6.00, from 0.60 to 6.50, from 0.60 to 5.50, from 0.60 to 5.00, from 1.00 to 8.00, from 1.00 to 7.50, from 1.00 to 7.00, from 1.00 to 6.00, from 1.00 to 6.50, from 1.00 to 5.50, from 1.00 to 5.00, from 1.40 to 8.00, from 1.40 to 7.50, from 1.40 to 7.00, from 1.40 to 6.00, from 1.40 to 6.50, from 1.40 to 5.50, from 1.40 to 5.00, from 1.80 to 8.00, from 1.80 to 7.50, from 1.80 to 7.00, from 1.80 to 6.00, from 1.80 to 6.50, from 1.80 to 5.50, from 1.80 to 5.00, from 2.20 to 8.00, from 2.20 to 7.50, from 2.20 to 7.00, from 2.20 to 6.00, from 2.20 to 6.50, from 2.20 to 5.50, from 2.20 to 5.00, from 2.60 to 8.00, from 2.60 to 7.50, from 2.60 to 7.00, from 2.60 to 6.00, from 2.60 to 6.50, from 2.60 to 5.50, from 2.20 to 5.00, from 3.00 to 8.00, from 3.00 to 7.50, from 3.00 to 7.00, from 3.00 to 6.00, from 3.00 to 6.50, from 3.00 to 5.50, or even from 3.00 to 5.00, or any and all sub-ranges formed from any of these endpoints.

Suitable commercial embodiments of the cross-linked silane grafted polyolefin are available under the BARRICADE brand from Avient, such as grades BA5400-0001, BA5400-0002, and BA54000-0003; and under the SYNCURE brand from Avient, such as grade S1054. Table 2 shows certain properties of BARRICADE BA5400-0001, BARRICADE BA5400-0002, BARRICADE BA5400-0003, and SYNCURE S1054.

TABLE 2

| | BARRICADE | BARRICADE | BARRICADE | SYNCURE |
|---|---|---|---|---|
| | BA5400-0001 | BA5400-0002 | BA5400-0003 | S1054 |
| Shore A | 75 | 81 | 64 | 95 |
| hardness | | | | |
| Compression set | 22 | 14 | 12 | 25 |
| (%) (23° C.) | | | | |
| Compression set | 23 | 17 | 12 | 65.6 |
| (%) (125° C.) | | | | |
| Tensile | 110 | 108 | 120 | 216 |
| elongationat | | | | |
| break (%) | | | | |
| Tensile strength | 6067 | 7860 | 3758 | 12045 |
| at break (kPa) | | | | |

Polymer Blends

As described herein, thermoplastic elastomer increases the tensile elongation and strength at break of the polymer blend, but may decrease the compression set of the polymer blend at higher temperatures (e.g., greater than or equal to 70° C.). While cross-linked silane grafted polyolefin increases the compression set of the polymer blend at higher temperatures, cross-linked silane grafted polyolefin may increase the Shore A hardness and decrease the tensile elongation and strength at break of the polymer blend. For example, a relatively low amount (e.g., less than 10 wt %) of cross-linked silane grafted polyolefin having a relatively high Shore A hardness (e.g., greater than 55) may significantly increase the Shore A hardness of the polymer blend when thermoplastic elastomer has a relatively low Shore A hardness (e.g., less than 10). This increase in the Shore A hardness of the polymer blend may be undesirable. Accordingly, in achieving a polymer blend having an improved compression set at higher temperatures as compared to a conventional thermoplastic elastomer blend, the amount of thermoplastic elastomer should be balanced with the amount cross-linked silane grafted polyolefin to maintain sufficient Shore A hardness and tensile elongation and strength and break and achieve the desired compression set at higher temperatures. In embodiments, the ratio by weight of thermoplastic elastomer to cross-linked silane grafted polyolefin (i.e., TPE to polyolefin) may be from 20:1 to 1:1, from 20:1 to 2:1, from 20:1 to 5:1, from 20:1 to 7:1, from 15:1 to 1:1, from 15:1 to 2:1, from 15:1 to 5:1, from 15:1 to 7:1, from 13:1 to 1:1, from 13:1 to 2:1, from 13:1 to 5:1, from 13:1 to 7:1, from 10:1 to 1:1, from 10:1 to 2:1, from 10:1 to 5:1, or even from 10:1 to 7:1, or any and all sub-ranges formed from any of these endpoints.

Cross-linked silane grafted polyolefin improves the compression set of the polymer blend at higher temperatures (e.g., greater than or equal to 70° C.). In embodiments, the polymer blend may comprise a compression set at 125° C. at least 3%, at least 5%, at least 10%, at least 20%, or even at least 30% lower than the compression set at 125° C. of the thermoplastic elastomer included in the polymer blend. In embodiments, the polymer blend may comprise a compression set at 125° C. from 3% to 70%, from 3% to 60%, 3% to 50%, from 3% to 40%, from 5% to 70%, from 5% to 60%, from 5% to 50%, from 5% to 40%, from 10% to 70%, from 10% to 60%, from 10% to 50%, from 10% to 40%, from 20% to 70%, from 20% to 60%, from 20% to 50%, from 20% to 40%, from 30% to 70%, from 30% to 60%, from 30% to 50%, or even from 30% to 40%, or any and all sub-ranges formed from these endpoints lower than the compression set at 125° C. of the thermoplastic elastomer included in the polymer blend.

In embodiments, the polymer blend may comprise a compression set at 70° C. at least 4%, at least 6%, at least 10%, at least 20%, or even at least 30% lower than the compression set at 70° C. of the thermoplastic elastomer included in the polymer blend. In embodiments, the polymer blend may comprise a compression set at 70° C. from 4% to 70%, from 4% to 60%, from 4% to 50%, from 4% to 40%, from 6% to 70%, from 6% to 60%, from 6% to 50%, from 6% to 40%, from 10% to 70%, from 10% to 60%, from 10% to 50%, from 10% to 40%, from 20% to 70%, from 20% to 60%, from 20% to 50%, from 20% to 40%, from 30% to 70%, from 30% to 60%, from 30% to 50%, or even from 30% to 40%, or any and all sub-ranges formed from these endpoints lower than the compression set at 70° C. of the thermoplastic elastomer included in the polymer blend.

In embodiments, the polymer blend may have a desired softness (e.g., Shore A hardness less than or equal to 80) required for customizable consumer, healthcare, and automotive applications. In embodiments, the polymer blend may have a Shore A hardness less than or equal to 80, less than or equal to 70, less than or equal to 60, less than or equal to 50, or even less than or equal to 40. In embodiments, the polymer blend may have a Shore A hardness greater than or equal to 3, greater than or equal to 5, greater than or equal to 10, greater than or equal to 20, or even greater than or equal to 30. In embodiments, the polymer blend may have a Shore A harness from 3 to 80, from 3 to 70, from 3 to 60, from 3 to 50, from 3 to 40, from 5 to 80, from 5 to 70, from 5 to 60, from 5 to 50, from 5 to 40, from 10 to 80, from 10 to 70, from 10 to 60, from 10 to 50, from 10 to 40, from 20 to 80, from 20 to 70, from 20 to 60, from 20 to 50, from 20 to 40, from 30 to 80, from 30 to 70, from 30 to 60, from 30 to 50, or even from 30 to 40, or any and all subranges formed from any of these endpoints.

In embodiments, the polymer blend may have a desired tensile elongation at break (e.g., greater than or equal to 150%) required for customizable consumer, healthcare, and automotive applications. In embodiments, the polymer blend may comprise a tensile elongation at break greater than or equal to 150%, greater than or equal to 250%, greater than or equal to 350%, or even greater than or equal to 450%. In embodiments, the polymer blend may comprise a tensile elongation at break less than or equal to 800%, less than or equal to 700%, or even less than or equal to 600%. In embodiment, the polymer blend may comprise a tensile elongation at break from 150% to 800%, from 150% to 700%, from 150% to 600%, from 250% to 800%, from 250% to 700%, from 250% to 600%, from 350% to 800%, from 350% to 700%, from 350% to 600%, from 450% to 800%, from 450% to 700%, or even from 450% to 600%, or any and all sub-ranges formed from any of these endpoints.

In embodiments, the polymer blend may have a desired tensile strength at break (e.g., greater than or equal to 500 kPa) required for customizable consumer, healthcare, and automotive applications. In embodiments, the polymer blend may comprise a tensile strength at break greater than or equal to 500 kPa, greater than or equal to 1000 kPa, or even greater than or equal to 3000 kPa. In embodiments, the polymer blend may comprise a tensile strength at break less than or equal to 7500 kPa, less than or equal to 6500 kPa, or even less than or equal to 5500 kPa. In embodiments, the polymer blend may comprise a tensile strength at break from 500 kPa to 7500 kPa, from 500 kPa to 6500 kPa, from 500 kPa to 5500 kPa, from 1000 kPa to 7500 kPa, from 1000 kPa to 6500 kPa, from 1000 kPa to 5500 kPa, from 3000 kPa to 7500 kPa, from 3000 kPa to 6500 kPa, or even from 3000 kPa to 5500 kPa, or any and all sub-ranges formed from any of these endpoints.

In embodiments, the polymer blend may comprise a specific gravity greater than or equal to 0.7, greater than or equal to 0.8, or even greater than or equal to 0.9. In embodiments, the polymer blend may comprise a specific gravity less than or equal to 1.3, less than or equal to 1.2, less than or equal to 1.1, or even less than or equal to 1.0. In embodiments, the polymer blend may comprise a specific gravity from 0.7 to 1.3, from 0.7 to 1.2, from 0.7 to 1.1, from 0.7 to 1.0, from 0.8 to 1.3, from 0.8 to 1.2, from 0.8 to 1.1, from 0.8 to 1.0, from 0.9 to 1.3, from 0.9 to 1.2, from 0.9 to 1.1, or even from 0.9 to 1.0, or any and all sub-ranges formed from any of these endpoints.

Catalyst

In embodiments, the polymer blend may further comprise a catalyst to initiate crosslinking of the cross-linked silane grafted polyolefin. In embodiments, the catalyst may comprise carboxylates of metals, such as tin, zinc, iron, lead and cobalt; organic bases; inorganic acids; and organic acids. Such catalysts may include, by way of example and not limitation, dibutyl tin dilaurate (DBTDL), dibutyl tin diacetate, dioctyl tin dilaurate, stannous acetate, stannous caprylate, lead naphthenate, zinc caprylate, cobalt naphthenate, ethyl amines, dibutyl amine, hexylamines, pyridine, inorganic acids, such as sulphuric acid and hydrochloric acid, as well as organic acids, such as toluene sulphonic acid, acetic acid, and stearic acid, and combinations thereof. In embodiments, the catalyst is blended with a silane grafted polyolefin and the silane grafted polyolefin will cross-link upon exposure to moisture (e.g., air).

In embodiments, the amount of catalyst in the polymer blend may be greater than 0 wt % or even greater than or equal to 0.1 wt %. In embodiments, the amount of the catalyst in the polymer blend may be less than or equal to 1 wt %, less than or equal to 0.75 wt %, or even less than or equal to 0.5 wt %. In embodiments, the amount of the catalyst in the polymer blend may be from 0 wt % to 1 wt %, from 0 wt % to 0.75 wt %, from 0 wt % to 0.5 wt %, from 0.1 wt % to 1 wt %, from 0.1 wt % to 0.75 wt %, or even from 0.1 wt % to 0.5 wt %, or any and all sub-ranges formed from any of these endpoints.

Filler

In embodiments, the polymer blend may further comprise a filler. In embodiments, the filler may comprise adhesion promoters; biocides; anti-fogging agents; anti-static agents; blowing and foaming agents; bonding agents and bonding polymers; dispersants; flame retardants and smoke suppressants; mineral fillers; initiators; lubricants; micas; pigments, colorants, and dyes; processing aids; release agents; silanes, titanates, and zirconates; slip and anti-blocking agents; stearates; ultraviolet light absorbers; viscosity regulators; waxes; or combinations thereof.

In embodiments, the amount of filler in the polymer blend may be greater than 0 wt %, greater than or equal to 0.25 wt %, greater than or equal to 0.5 wt %, greater than or equal to 1 wt %, or even greater than or equal to 2 wt %. In embodiments, the amount of the filler in the polymer blend may be less than or equal to 35 wt %, less than or equal to 20 wt %, less than or equal to 10 wt %, or even less than or equal to 50 wt %. In embodiments, the amount of the filler in the polymer blend may be from 0 wt % 35 wt %, from 0 wt % to 20 wt %, from 0 wt % to 10 wt %, from 0 wt % to 5 wt %, from 0.25 wt % 35 wt %, from 0.25 wt % to 20 wt %, from 0.25 wt % to 10 wt %, from 0.25 wt % to 5 wt %, from 0.5 wt % 35 wt %, from 0.5 wt % to 20 wt %, from 0.5 wt % to 10 wt %, from 0.5 wt % to 5 wt %, from 1 wt % 35 wt %, from 1 wt % to 20 wt %, from 1 wt % to 10 wt %, from 1 wt % to 5 wt %, from 2 wt % 35 wt %, from 2 wt % to 20 wt %, from 2 wt % to 10 wt %, or even from 2 wt % to 5 wt %, or any and all sub-ranges formed from any of these endpoints.

from 0 wt % to 0.75 wt %, from 0 wt % to 0.5 wt %, from 0.1 wt % to 1 wt %, from 0.1 wt % to 0.75 wt %, or even from 0.1 wt % to 0.5 wt %, or any and all sub-ranges formed from any of these endpoints.

Suitable commercial embodiments of the filler are available under the IRGAFOS 168 brand from BASF, such as grade 168; under the IRGANOX brand from BASF, such as grades 1098 and 1010; under the HOSTANOX brand from Clariant, such as grade P-EPQ; and under the CYASORB® brand from Solvay, such as grade UV-1164.

Processing

In embodiments, the polymer blend described herein may be made with batch process or continuous process.

In embodiments, the components of the polymer blend may be added all together in an extruder and mixed. In embodiments, mixing may be a continuous process at an elevated temperature (e.g., 180° C.-220° C.) that is sufficient to melt the polymer matrix. In embodiments, fillers may be added at the feed-throat, or by injection or side-feeders downstream. In embodiments, the output from the extruder is pelletized for later extrusion, molding, thermoforming, foaming, calendaring, and/or other processing into polymeric articles.

### EXAMPLES

Table 3 shows sources of ingredients for the polymer blends of Comparative Examples C1-C8 and Examples 1-43

TABLE 3

| | | | Shore A | Compression set |
|---|---|---|---|---|
| Ingredient | Brand | Source | hardness | (%) (125° C.) |
| Extra soft SEBS gel TPE | VERSAFLEX 2800-17 | Avient | 0 | 100.0 |
| Extra soft SEBS gel TPE | VERSAFLEX CL 2003X | Avient | 0 | 100.0 |
| Extra soft SEBS gel TPE | VERSAFLEX CL 2000X | Avient | 3 | 100.0 |
| Soft SEBS TPE | VERSAFLEX CL 30 | Avient | 30 | 100.0 |
| Medium soft SEBS TPE | — | — | 44 | 93.4 |
| (hereinafter “MS SEBS TPE”) | | | | |
| Medium soft SEBS TPE | VERSAFLEX OM 1040X-1 | Avient | 42 | 82.1 |
| Soft VDT | VERSAFLEX VDT 4132 | Avient | 32 | 100.0 |
| Medium hard TPU/SEBS alloy | VERSAFLEX CE 3120-65 | Avient | 67 | 98.0 |
| Silane grafted olefin elastomer | BARRICADE BA5400-0001 | Avient | 75 | 23.0 |
| including polypropylene | | | | |
| Silane grafted olefin elastomer | BARRICADE BA5400-0003 | Avient | 81 | 17.0 |
| including polypropylene | | | | |
| Silane grafted olefin elastomer | SYNCURE S1054A | Avient | 95 | 65.6 |
| including polyethylene | | | | |

Table 4 shows the formulations (in wt %) and certain properties of Comparative Examples C1-C3 and Examples 1-15, which include extra soft SEBS gel TPE (i.e., Shore A hardness from 0-10). Comparative Example C1 and Examples 1-4 include different ratios of VERSAFLEX 2800-17 to BARRICADE 5400-0001. Comparative Example C2 and Examples 5 and 6 include different ratios of VERSAFLEX CL 2003X to BARRICADE 5400-0001. Comparative Example C3 and Examples 7-15 include different ratios of VERSAFLEX CL 2000 to BARRICADE 5400-0001, BARRICADE 5400-0001, and SYNCURE S1054A, respectively.

TABLE 4

| Examples | C1 | 1 | 2 | 3 | 4 | C2 | 5 |
|---|---|---|---|---|---|---|---|
| Ratio of TPE to polyolefin | 1:0 | 14.9:1 | 10.0:1 | 7.5:1 | 5.0:1 | 1:0 | 10.0:1 |
| VERSAFLEX 2800-17 | 100.0 | 93.7 | 90.9 | 88.2 | 83.3 | — | — |
| VERSAFLEX CL 2003X | — | — | — | — | — | 100.0 | 90.9 |
| VERSAFLEX CL 2000X | — | — | — | — | — | — | — |
| BARRICADE | — | 6.3 | 9.1 | 11.8 | 16.7 | — | 9.1 |
| BA5400-0001 | | | | | | | |
| BARRICADE | — | — | — | — | — | — | — |
| BA5400-0003 | | | | | | | |
| SYNCURES1054A | — | — | — | — | — | — | — |
| Shore A hardness | 0 | 0 | 0 | 0 | 10 | 0 | 0 |
| Compressionset (%) | 14.2 | 8.8 | 13.2 | 10.0 | 5.6 | 41.0 | 12.4 |
| (23° C.) | | | | | | | |
| Compressionset (%) | 100.0 | 92.6 | 60.9 | 67.4 | 35.9 | 100.0 | 92.2 |
| (70° C.) | | | | | | | |
| Compression set | — | 7.4 | 39.1 | 32.6 | 64.1 | — | 7.8 |
| difference between | | | | | | | |
| Comparative Example and | | | | | | | |
| Example at 70° C. (%) | | | | | | | |
| Compressionset (%) | 100.0 | 100.0 | 100.0 | 93.8 | 96.5 | 100.0 | 100.0 |
| (125° C.) | | | | | | | |
| Compression set | — | 0.0 | 0.0 | 6.2 | 3.5 | — | 0.0 |
| difference between | | | | | | | |
| Comparative Example and | | | | | | | |
| Example at 125° C. (%) | | | | | | | |
| Tensile elongation | 1131 | 798 | — | 378 | — | 1889 | — |
| at break (%) | | | | | | | |
| Tensile strength | 1241 | 1131 | — | 533 | — | — | — |
| at break (kPa) | | | | | | | |
| Specific gravity | — | 0.80 | 0.90 | 0.80 | 0.90 | — | 0.90 |
| Examples | 6 | C3 | 7 | 8 | 9 | 10 | 11 |
| Ratio of TPE to polyolefin | 5.0:1 | 1:0 | 7.5:1 | 10.0:1 | 7.5:1 | 5.0:1 | 2.5:1 |
| VERSAFLEX 2800-17 | — | — | — | — | — | — | — |
| VERSAFLEX CL 2003X | 83.3 | — | — | — | — | — | 1 |
| VERSAFLEX CL 2000X | — | 100.0 | 88.2 | 90.9 | 88.2 | 83.3 | 71.4 |
| BARRICADE BA5400-0001 | 16.7 | — | 11.8 | — | — | — | — |
| BARRICADE BA5400-0003 | — | — | — | 9.1 | 11.8 | 16.7 | 28.6 |
| SYNCURES1054A | — | — | — | — | — | — | — |
| Shore A hardness | 10 | 0 | 6 | 14 | 16 | 20 | 27 |
| Compressionset (%) | 13.0 | 37.3 | 17.5 | 23.2 | 21.2 | 18.7 | 17.0 |
| (23° C.) | | | | | | | |
| Compressionset (%) | 68.0 | 100.0 | 75.5 | — | — | — | — |
| (70° C.) | | | | | | | |
| Compression set | 32.0 | — | 24.5 | — | — | — | — |
| difference between | | | | | | | |
| Comparative Example and | | | | | | | |
| Example at 70° C. (%) | | | | | | | |
| Compressionset (%) | 77.9 | 100.0 | 66.8 | 55.4 | 50.2 | 53.3 | 53.8 |
| (125° C.) | | | | | | | |
| Compression set | 22.1 | — | 33.2 | 44.6 | 49.8 | 46.7 | 46.2 |
| difference between | | | | | | | |
| Comparative Example and | | | | | | | |
| Example at 125° C. (%) | | | | | | | |
| Tensile elongation | — | 1402 | 407 | — | — | — | — |
| at break (%) | | | | | | | |
| Tensile strength | — | 1988 | 914 | — | — | — | — |
| at break (kPa) | | | | | | | |
| Specific gravity | 0.90 | — | 0.90 | 0.85 | 0.85 | 0.85 | 0.85 |
| Examples | 12 | 13 | 14 | 15 | | | |
| Ratio of TPE to polyolefin | 10.1:1 | 7.3:1 | 5.5:1 | 2.4:1 | | | |
| VERSAFLEX 2800-17 | — | — | — | — | | | |
| VERSAFLEX CL 2003X | — | — | — | — | | | |
| VERSAFLEX CL 2000X | 91.0 | 88.0 | 93.0 | 71.0 | | | |
| BARRICADE BA5 400-0001 | — | — | — | — | | | |
| BARRICADE BA5 400-0003 | — | — | — | — | | | |
| SYNCURES1054A | 9.0 | 12.0 | 17.0 | 29.0 | | | |
| Shore A hardness | 20 | 24 | 32 | 26 | | | |
| Compressionset (%) | 22.2 | 23.8 | 23.2 | 24.4 | | | |
| (23° C.) | | | | | | | |
| Compressionset (%) | — | — | — | — | | | |
| (70° C.) | | | | | | | |
| Compression set | — | — | — | — | | | |
| difference between | | | | | | | |
| Comparative Example and | | | | | | | |
| Example at 70° C. (%) | | | | | | | |
| Compressionset (%) | 81.0 | 82.5 | 81.0 | 81.0 | | | |
| (125° C.) | | | | | | | |
| Compression set | 19.0 | 17.5 | 19.0 | 19.0 | | | |
| difference between | | | | | | | |
| Comparative Example and | | | | | | | |
| Example at 125° C. (%) | | | | | | | |
| Tensile elongation | — | — | — | — | | | |
| at break (%) | | | | | | | |
| Tensile strength | — | — | — | — | | | |
| at break (kPa) | | | | | | | |
| Specific gravity | 0.87 | 0.87 | 0.88 | 0.88 | | | |

As shown in Table 4, Examples 1-7 show significant improvement in compression set at 70° C. as compared to Comparative Examples 1-3, respectively. Examples 1-15 show significant improvement in compression set at 125° C. as compared to Comparative Examples C1-C₃, respectively. As indicated by the examples shown in Table 4, including cross-linked silane grafted polyolefin improves the compression set of the polymer blends at higher temperatures (e.g., 70° C. and 125° C.) as compared to the compression set of the thermoplastic elastomer.

The Examples of Table 4 also indicate that a relatively low amount of cross-linked silane grafted polyolefin is needed to significantly improve the compression set of the polymer blend at higher temperatures when the thermoplastic elastomer of the polymer blend has a relatively low hardness (i.e., Shore A hardness from 0 to 10). For example, Examples 2 and 5, 10.0:1 polymer blends of VERSAFLEX 2800-1 and VERSAFLEX CL 2003X respectively, to cross-linked silane grafted polyolefin, have a compression set at 70° C. of 39.1% and 7.8%, respectively, lower than the respective Comparative Examples C1 and C2, TPE without cross-linked silane grafted polyolefin. Examples 3, 6, and 9, 7.5:1 blends of VERSAFLEX 2800-1, VERSAFLEX CL 2003X, and VERSAFLEX CL 2000X respectively, to cross-linked silane grafted polyolefin, have a compression set at 125° C. of 6.2%, 22.1%, and 49.8%, respectively, lower than the respective Comparative Examples, C1, C2, and C3, TPE without cross-linked silane grafted polyolefin.

As further shown in Table 4, while Examples 12-15, polymer blends of VERSAFLEX CL 2000X and SYNCURE S1054A, showed significant improvement in compression set at 125° C. as compared to Comparative Example 3, Examples 7-11, polymer blends of VERSAFLEX CL 2000X with BARRICADE BA5400-0001 and BARRICADE BA5400-0003, respectively, showed more improvement at similar thermoplastic elastomer to cross-linked silane grafted polyole fin ratios. As indicated by the examples in Table 4, polymer blends having cross-linked silane grafted olefin including polypropylene may have better compression set values than polymer blends having cross-linked silane grafted olefin including polyethylene.

Moreover, as shown in Table 4, the Shore A hardness of the polymer blends increase as the amount of cross-linked silane grafted polyolefin increases, due to the extra soft SEBS gel TPE included in the polymer blends. Furthermore, the tensile elongation and strength of the polymer blends may decrease depending on the amount of cross-linked silane grafted polyolefin added. As indicated by the examples in Table 4, the amount of cross-linked silane grafted polyolefin may need to be limited such that the Shore A hardness is not increased above a desired value (e.g., less than or equal to 80) and tensile elongation and strength at break of the polymer blend are not reduced below a desired value (e.g., greater than or equal to 150% and greater than or equal to 500 kPa, respectively).

Table 5 shows the formulations (in wt %) and certain properties of Comparative Examples C4-C6 and Examples 16-35, which include soft (i.e., Shore A hardness from 10 to 40) and medium soft (i.e., Shore A hardness from 40 to 60) SEBS TPE. Comparative Example C4 and Examples 16-28 include different ratios of VERSAFLEX CL 30 to BARRICADE 5400-0001, BARRICADE 5400-0001, and SYNCURE S1054A, respectively. Comparative Example C5 and Examples 29-32 include different ratios of MS SEBS TPE to BARRICADE 5400-0001. Comparative Example C6 and Examples 33-35 include different ratios of VERSAFLEX OM 1040X-1 to BARRICADE BA5400-0003.

TABLE 5

| Examples | C4 | 16 | 17 | 18 | 19 | 20 | 21 |
|---|---|---|---|---|---|---|---|
| Ratio of TPE to polyolefin | 1:0 | 19.8:1 | 14.9:1:1 | 10.0:1 | 5.0:1 | 10.0:1 | 7.5:1 |
| VERSAFLEX CL 30 | 100.0 | 95.2 | 93.7 | 90.9 | 83.3 | 90.9 | 88.2 |
| MS SEBSTPE | — | — | — | — | — | — | — |
| VERSAFLEX OM 1040X-1 | — | — | — | — | — | — | — |
| BARRICADE BA5400-0001 | — | 4.8 | 6.3 | 9.1 | 16.7 | — | — |
| BARRICADE BA5400-0003 | — | — | — | — | — | 9.1 | 11.8 |
| SYNCURES1054A | — | — | — | — | — | — | — |
| Shore A hardness | 26 | 32 | 34 | 35 | 39 | 35 | 36 |
| Compressionset (%) | 18.4 | 13.1 | 12.5 | 13.2 | 14.4 | 12.8 | 13.3 |
| (23° C.) | | | | | | | |
| Compressionset (%) | 100.0 | 92.7 | 84.0 | 79.5 | 70.9 | — | — |
| (70° C.) | | | | | | | |
| Compression set | — | 7.3 | 16.0 | 20.5 | 29.1 | — | — |
| difference between | | | | | | | |
| Comparative Example and | | | | | | | |
| Example at 70° C. (%) | | | | | | | |
| Compressionset (%) | 100.0 | — | — | 73.9 | 66.4 | 35.9 | 40.8 |
| (125° C.) | | | | | | | |
| Compression set | — | — | — | 26.1 | 33.6 | 64.1 | 59.2 |
| difference between | | | | | | | |
| Comparative Example and | | | | | | | |
| Example at 125° C. (%) | | | | | | | |
| Tensile elongation | 776 | 563 | 422 | 467 | 324 | — | — |
| at break (%) | | | | | | | |
| Tensile strength | — | — | — | — | — | — | — |
| at break (kPa) | | | | | | | |
| Specific gravity | — | 0.90 | 0.90 | 0.90 | 0.90 | 0.87 | 0.87 |
| Examples | 22 | 23 | 24 | 25 | 26 | 27 | 28 |
| Ratio of TPE to polyolefin | 5.0:1 | 2.5:1 | 1:1 | 10.1:1 | 7.3:1 | 5.5:1 | 2.4:1 |
| VERSAFLEX CL 30 | 83.3 | 71.4 | 50.0 | 91.0 | 88.0 | 93.0 | 71.0 |
| MS SEBSTPE | — | — | — | — | — | — | — |
| VERSAFLEX OM | — | — | — | — | — | — | — |
| 1040X-1 | | | | | | | |
| BARRICADE | — | — | — | — | — | — | — |
| BA5400-0001 | | | | | | | |
| BARRICADE | 16.7 | 28.6 | 50.0 | — | — | — | — |
| BA5400-0003 | | | | | | | |
| SYNCURES1054A | — | — | — | 9.0 | 12.0 | 17.0 | 29.0 |
| Shore A hardness | 39 | 43 | 53 | 44 | 48 | 54 | 66 |
| Compressionset (%) | 15.0 | 17.0 | 21.0 | — | — | — | — |
| (23° C.) | | | | | | | |
| Compressionset (%) | — | — | — | — | — | — | — |
| (70° C.) | | | | | | | |
| Compression set | — | — | — | — | — | — | — |
| difference between | | | | | | | |
| Comparative Example and | | | | | | | |
| Example at 70° C. (%) | | | | | | | |
| Compressionset (%) | 62.0 | 65.0 | 63.0 | 77.0 | 72.0 | 75.0 | 78.5 |
| (125° C.) | | | | | | | |
| Compression set | 38.0 | 35.0 | 37.0 | 23.0 | 28.0 | 25.0 | 21.5 |
| difference between | | | | | | | |
| Comparative Example and | | | | | | | |
| Example at 125° C. (%) | | | | | | | |
| Tensile elongation | — | — | — | — | — | — | — |
| at break (%) | | | | | | | |
| Tensile strength | — | — | — | — | — | — | — |
| at break (kPa) | | | | | | | |
| Specific gravity | 0.89 | 0.88 | 0.88 | 0.89 | 0.89 | 0.89 | 0.90 |
| Examples | C5 | 29 | 30 | 31 | 32 | C6 | 33 |
| Ratio of TPE to polyolefin | 1:0 | 14.9:1 | 10.0:1 | 5.0:1 | 2.5:1 | 1:1 | 10.1:1 |
| VERSAFLEX CL 30 | — | — | — | — | — | — | — |
| MS SEBSTPE | 100.0 | 93.7 | 90.9 | 83.3 | 71.4 | — | — |
| VERSAFLEX OM 1040X-1 | — | — | — | — | — | 100.0 | 90.9 |
| BARRICADE BA5400-0001 | — | 6.3 | 9.1 | 16.7 | 28.6 | — | — |
| BARRICADE BA5400-0003 | — | — | — | — | — | — | 9.1 |
| SYNCURES1054A | — | — | — | — | — | — | — |
| Shore A hardness | 44 | 53 | 54 | 57 | 58 | 44 | 46 |
| Compressionset (%) | 21.1 | 21.7 | 23.8 | 23.3 | 29.1 | 44.7 | 40.6 |
| (23° C.) | | | | | | | |
| Compressionset (%) | 54.3 | 44.4 | 39.1 | 35.4 | 37.2 | — | — |
| (70° C.) | | | | | | | |
| Compression set | — | 9.9 | 15.2 | 18.9 | 17.1 | — | — |
| difference between | | | | | | | |
| Comparative Example and | | | | | | | |
| Example at 70° C. (%) | | | | | | | |
| Compressionset (%) | 93.4 | 70.7 | 65.7 | 62. | 54.3 | 82.1 | 76.6 |
| (125° C.) | | | | | | | |
| Compression set | — | 22.7 | 27.7 | 30.9 | 39.1 | — | 5.5 |
| difference between | | | | | | | |
| Comparative Example and | | | | | | | |
| Example at 125° C. (%) | | | | | | | |
| Tensile elongation | 812 | 289 | 316 | 315 | 192 | — | — |
| at break (%) | | | | | | | |
| Tensile strength | 3893 | 2757 | 2770 | 3314 | 3634 | — | — |
| at break (kPa) | | | | | | | |
| Specific gravity | 1.10 | 1.10 | 1.10 | 1.10 | 1.00 | 0.91 | 0.91 |
| Examples | 34 | 35 | | | | | |
| Ratio of TPE to polyolefin | 5.0:1 | 2.5:1 | | | | | |
| VERSAFLEX CL 30 | — | — | | | | | |
| MS SEBSTPE | — | — | | | | | |
| VERSAFLEX OM 1040X-1 | 83.3 | 71.4 | | | | | |
| BARRICADE BA5400-0001 | — | — | | | | | |
| BARRICADE BA5400-0003 | 16.7 | 28.6 | | | | | |
| SYNCURES1054A | — | — | | | | | |
| Shore A hardness | 50 | 53 | | | | | |
| Compressionset (%) | 38.8 | 34.1 | | | | | |
| (23° C.) | | | | | | | |
| Compressionset (%) | — | — | | | | | |
| (70° C.) | | | | | | | |
| Compression set | — | — | | | | | |
| difference between | | | | | | | |
| Comparative Example and | | | | | | | |
| Example at 70° C. (%) | | | | | | | |
| Compressionset (%) | 64.1 | 43.3 | | | | | |
| (125° C.) | | | | | | | |
| Compression set | 18.0 | 38.8 | | | | | |
| difference between | | | | | | | |
| Comparative Example and | | | | | | | |
| Example at 125° C. (%) | | | | | | | |
| Tensile elongation | — | — | | | | | |
| at break (%) | | | | | | | |
| Tensile strength | — | — | | | | | |
| at break (kPa) | | | | | | | |
| Specific gravity | 0.91 | 0.90 | | | | | |

As shown in Table 5, Examples 16-19 and 29-32 show significant improvement in compression set at 70° C. as compared to Comparative Examples 4-6, respectively. Examples 18-35 show significant improvement in compression set at 125° C. as compared to Comparative Examples C4-C6, respectively. As indicated by the examples shown in Table 3, including cross-linked silane grafted polyolefin improves the compression set of the polymer blends at higher temperatures (e.g., 70° C. and 125° C.) as compared to the compression set of the thermoplastic elastomer.

As further shown in Table 5, the Shore A hardness of the polymer blends increase as the amount of cross-linked silane grafted polyolefin increases, due to the soft and medium soft SEBS TPE included in the polymer blends. Furthermore, the tensile elongation and strength of the polymer blends may decrease depending on the amount of cross-linked silane grafted polyolefin added. As indicated by the examples in Table 5, the amount of cross-linked silane grafted polyolefin may need to be limited such that the Shore A Hardness is not increase above a desired value (e.g., less than or equal to 80) and tensile elongation and strength at break of the polymer blend are not reduced below a desired value (e.g., greater than or equal to 150% and greater than or equal to 500 kPa, respectively).

Table 6 shows the formulations (in wt %) and certain properties of Comparative Examples C7 and C8 and Examples 36-43, which include soft (i.e., Shore A hardness from 10 to 40) and medium hard (i.e., Shore A hardness from 60 to 80) thermoplastic elastomers. Comparative Example C7 and Examples 36 and 37 include different ratios of VERSAFLEX VDT 4132 to BARRICADE BA5400-0001. Comparative Examples C8 and Examples 38-43 include different ratios of VERSAFLEX CE 3120-65 to BARRICADE BA5400-0001 and BARRICADE BA5400-0003, respectively.

TABLE 6

| Examples | C7 | 36 | 37 | C8 | 38 | 39 | 40 |
|---|---|---|---|---|---|---|---|
| Ratio of TPE to polyolefin | 1:0 | 10.1:1 | 5.0:1 | 1:0 | 10.1:1 | 5.0:1 | 2.5:1 |
| VERSAFLEX VDT 4132 | 100.0 | 90.9 | 83.3 | — | — | — | — |
| VERSAFLEX CE 3120-65 | — | — | — | 100.0 | 90.9 | 83.3 | 71.4 |
| BARRICADE BA5400-0001 | — | 9.1 | 16.7 | — | 9.1 | 16.7 | 28.6 |
| BARRICADE BA5400-0003 | — | — | — | — | — | — | — |
| Shore A hardness | 32 | 31 | 36 | 70 | 67 | 64 | 67 |
| Compressionset (%) | 15.6 | 13.9 | 12.4 | 40.3 | 19.7 | 19.3 | 20.4 |
| (23° C.) | | | | | | | |
| Compressionset (%) | 100.0 | 92.7 | 87.0 | 72.7 | 60.5 | 61.2 | 59.8 |
| (70° C.) | | | | | | | |
| Compression set | — | 7.3 | 13.0 | — | 12.2 | 11.5 | 12.9 |
| difference between | | | | | | | |
| Comparative Example and | | | | | | | |
| Example at 70° C. (%) | | | | | | | |
| Compressionset (%) | 100.0 | 100.0 | 80.4 | 98.0 | 93.9 | 77.7 | 74.8 |
| (125° C.) | | | | | | | |
| Compression set | — | 0.0 | 19.6 | — | 4.1 | 20.3 | 23.2 |
| difference between | | | | | | | |
| Comparative Example and | | | | | | | |
| Example at 125° C. (%) | | | | | | | |
| Tensile elongation (%) | 710 | — | — | 644 | 470 | 372 | 295 |
| Tensile strength (kPa) | 4785 | — | — | 13765 | 7040 | 5730 | 5026 |
| Specific gravity | — | 0.90 | 0.90 | 1.20 | 1.10 | 1.10 | 1.00 |
| Examples | 41 | 42 | 43 | | | | |
| Ratio of TPE to polyolefin | 7.5:1 | 5.0:1 | 2.5:1 | | | | |
| VERSAFLEX VDT 4132 | — | — | — | | | | |
| VERSAFLEX CE 3120-65 | 88.2 | 83.3 | 71.4 | | | | |
| BARRICADE BA5400-0001 | — | — | — | | | | |
| BARRICADE BA5400-0003 | 11.8 | 16.7 | 28.6 | | | | |
| Shore A hardness | 68 | 66 | 65 | | | | |
| Compressionset (%) | 24.6 | 25.4 | 25.6 | | | | |
| (23° C.) | | | | | | | |
| Compressionset (%) | — | — | — | | | | |
| (70° C.) | | | | | | | |
| Compression set | — | — | — | | | | |
| difference between | | | | | | | |
| Comparative Example and | | | | | | | |
| Example at 70° C. (%) | | | | | | | |
| Compressionset (%) | 94.5 | 92.2 | 84.2 | | | | |
| (125° C.) | | | | | | | |
| Compression set | 3.5 | 5.8 | 13.8 | | | | |
| difference between | | | | | | | |
| Comparative Example and | | | | | | | |
| Example at 125° C. (%) | | | | | | | |
| Tensile elongation (%) | — | — | — | | | | |
| Tensile strength (kPa) | — | — | — | | | | |
| Specific gravity | 1.11 | 1.09 | 1.05 | | | | |

As shown in Table 6, Examples 36 and 37 show significant improvement in compression set at 70° C. as compared to Comparative Example C7. Examples 36-43 show significant improvement in compression set at 125° C. as compared to Comparative Examples C7 and C8, respectively. As indicated by the examples shown in Table 6, including cross-linked silane grafted polyolefin improves the compression set of the polymer blends at higher temperatures (e.g., 70° C. and 125° C.) as compared to the compression set of the thermoplastic elastomer.

As further shown in Table 6, the Shore A hardness of Example 37 is higher than the Shore A hardness of Comparative Examples C7, due to the soft VDT included in Example 37. Note that the Shore A hardness of Examples 38-43 are not higher than the Shore A hardness of Comparative Example C8, due to the medium hard TPU/SEBS alloy included in the polymer blends. Moreover, the tensile elongation and strength of the polymer blends decrease depending on the amount of cross-linked silane grafted polyolefin added. As indicated by the examples in Table 6, the amount of cross-linked silane grafted polyolefin may need to be limited such that the Shore A hardness is not increased above a desired value (e.g., less than or equal to 80) and tensile elongation and strength at break of the polymer blend are not reduced below a desired value (e.g., greater than or equal to 150% and greater than or equal to 500 kPa, respectively).

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A polymer blend comprising:
thermoplastic elastomer comprising a Shore A hardness from 0 to 80 as measured in accordance with ASTM D2240 and a compression set greater than or equal to 80% as measured in accordance with ASTM D395 at 125° C.; and
4 wt % to 50 wt % of cross-linked silane grafted polyolefin comprising a compression set less than or equal to 70% as measured in accordance with ASTM D395 at 125° C.

2. The polymer blend of claim 1, wherein the thermoplastic elastomer comprises a styrene copolymer.

3. The polymer blend of claim 2, wherein the styrene copolymer comprises a styrene-butadiene block copolymer (SBC).

4. The polymer blend of claim 3, wherein the SBC comprises a styrene-ethylene/butyl ene-styrene block copolymer (SEBS), a styrene-(ethylene/propylene)-styrene block copolymer (SEEPS), a styrene isoprene block copolymer (SIS), a styrene-isobutylene-styrene block copolymer (SIBS), or combinations thereof.

5. The polymer blend of claim 1, wherein the thermoplastic elastomer further comprises vibration damping thermoplastic elastomer (VDT), thermoplastic polyurethane (TPU), thermoplastic vulcanizate (TPV), thermoplastic polyolefins (TPO), thermoplastic copolyester elastomer (TPC), polyamide thermoplastic elastomer (TPA), thermoplastic styrenic elastomer (TPS), or combinations thereof.

6. The polymer blend of claim 1, wherein the cross-linked silane grafted polyolefin comprises polyethylene, polypropylene, or combinations thereof.

7. The polymer blend of claim 1, wherein the cross-linked silane grafted polyolefin is dispersed within the thermoplastic elastomer.

8. The polymer blend of claim 1, wherein cross-linked silane grafted polyolefin comprising a compression set less than or equal to 25% as measured in accordance with ASTM D395 at 125° C.

9. The polymer blend of claim 1, wherein the ratio by weight of the thermoplastic elastomer to the cross-linked silane grafted polyolefin is from 20:1 to 1:1.

10. The polymer blend of claim 9, wherein the ratio by weight of the thermoplastic elastomer to the cross-linked silane grafted polyolefin is from 15:1 to 2:1.

11. The polymer blend of claim 10, wherein the ratio by weight of the thermoplastic elastomer to the cross-linked silane grafted polyolefin is from 13:1 to 5:1.

12. The polymer of claim 1, wherein the polymer blend comprises a compression set at least 3% lower than a compression set of the thermoplastic elastomer as measured in accordance with ASTM D395 at 125° C.

13. The polymer blend of claim 12, wherein the polymer blend comprises a compression set from 3% to 70% lower than a compression set of the thermoplastic elastomer as measured in accordance with ASTM D395 at 125° C.

14. The polymer of claim 1, wherein the polymer blend comprises a compression set at least 4% lower than a compression set of the thermoplastic elastomer as measured in accordance with ASTM D395 at 70° C.

15. The polymer blend of claim 14, wherein the polymer blend comprises a compression set from 4% to 70% lower than a compression set of the thermoplastic elastomer as measured in accordance with ASTM D395 at 70° C.

16. The polymer blend of claim 1, wherein the polymer blend comprises a specific gravity from 0.70 to 1.30 as measured according to ASTM D792.
